(19) United States
(12) Patent Application Publication
(10) Pub. No.: US 2004/0145685 A1
(43) Pub. Date: Jul. 29, 2004

(54) Conversion module for liquid crystal display

(76) Inventor: Chi-Chang Chang, Taipei (TW)

Correspondence Address: RABIN & Berdo, PC, 1101 14TH STREET, NW, SUITE 500, WASHINGTON, DC, 20005, US

(21) Appl. No.: 10/733,259

(22) Filed: Dec. 12, 2003

(30) Foreign Application Priority Data
Apr. 3, 2003 (TW) 92205241
Aug. 20, 2002 (JP) 2002-239562
Aug. 19, 2003 (JP) 2003-295585

(51) Int. Cl. G02F 1/13; G02F 1/133

(52) U.S. Cl. 349/1; 349/20

(57) ABSTRACT

An electronic device with a conversion module for a liquid crystal display. The electronic device includes a motherboard, a liquid crystal display, a fixing member, a cushion member, and a converter board. The motherboard includes a heat dissipation module. The converter board is coupled to the motherboard and the liquid crystal display respectively, and converts a first signal from the motherboard to a second signal suitable for use by the liquid crystal display. The fixing member connects the converter board and the heat dissipation module so that the converter board is fixed on the heat dissipation module. The cushion member is disposed between the converter board and the heat dissipation module.

### BACKGROUND OF THE INVENTION

1. Field of the Invention

The invention relates to an electronic device and a conversion module for a liquid crystal display thereof; in particular, to an electronic device with a stably-disposed conversion module thereof.

2. Description of the Related Art

In a conventional desktop computer, a CRT monitor is often used as a display thereof. The space required by the CRT monitor, however, is large and therefore may be inconvenient.

Recently, as liquid crystal displays have become less expensive, they are often used as displays for desktop computers, replacing CRT monitors.

The arrangement of the conventional desktop computer 10 is shown in FIG. 1. The desktop computer 10 includes a motherboard 11 and a liquid crystal display 12. The liquid crystal display 12 is connected to a connector 15 on the motherboard 11 via a flat cable 13 and a connector 14 so that the liquid crystal display 12 is coupled to the motherboard 11. It is noted that since the signal used in the liquid crystal display 12 is different from that in the motherboard 11, a conversion circuit 16 is usually disposed on the motherboard 11. Thus, the signal of the motherboard 11 can be converted into a signal suitable for use by the liquid crystal display 12.

Furthermore, the type of conversion circuit and connector depends on the specification of the liquid crystal display. For example, the conversion circuit and the connectors may be LVDS (low voltage differential signaling) type or TMDS (transition minimized differential scaling) type. An LVDS type conversion device is disclosed in U.S. Pat. No. 5,815,735.

It is noted that notebook computers are not included in the consideration of this invention. Specifically, since the liquid crystal display is normally used as the display of the notebook computer, a chipset for converting the liquid crystal display is disposed on the motherboard of the notebook computer. Thus, in the notebook computer, the connectors and the conversion device as stated above are not required.

As stated above, for coupling to the liquid crystal display, the connector and the conversion circuit are additionally disposed on the motherboard. However, as motherboards become smaller, the arrangement of components on the motherboard becomes more difficult. Thus, it is important to minimize the size of the motherboard without reducing functionality.

FIG. 2 shows an electronic device 100 with a minimized motherboard that is disclosed in the co-pending U.S. application Ser. No. 10/646,733. In the electronic device 100, a conversion module 130 for a liquid crystal display is additionally disposed so as to minimize the size of the motherboard.

Specifically, the conversion module 130 is disposed on the motherboard 110. The conversion module 130 is coupled to the motherboard 110 via a connector 132, and is coupled to the liquid crystal display 120 via a connector 133. The conversion module 130 includes a circuit board 131 with a conversion circuit so that the signal from the motherboard 110 can be converted into the signal suitable for use by the liquid crystal display 120. By moving the conversion circuit to another circuit board from the motherboard, the area occupied by the layout of the circuit on the motherboard can be reduced. Thus, the size of the motherboard can be minimized.

However, as shown in FIG. 2, since the circuit board 131 of the conversion module 130 is fixed on the motherboard 110 by the connectors 111, 132, it is not stable. When the electronic device 100 vibrates, the conversion module 130 may be separated from the motherboard 110. Thus, stable positioning of the conversion module on the motherboard is a problem to be solved

### SUMMARY OF THE INVENTION

In view of this, the invention provides an electronic device with a stably-disposed conversion module for a liquid crystal display.

Accordingly, the invention provides an electronic device including a motherboard, a liquid crystal display, a fixing member, a cushion member, and a converter board. The motherboard includes a heat dissipation module. The converter board is coupled to the motherboard and the liquid crystal display respectively, and converts a first signal from the motherboard to a second signal suitable for use by the liquid crystal display. The fixing member connects the converter board and the heat dissipation module so that the converter board is fixed on the heat dissipation module. The cushion member is disposed between the converter board and the heat dissipation module.

In a preferred embodiment, the electronic device further includes a first connector and a second connector. The first connector is disposed on the motherboard. The second connector corresponds to the first connector, and is disposed on the converter board. The first signal is transmitted to the converter board by the first connector connected to the second connector.

Furthermore, the first connector, the second connector, and the converter board are LVDS type.

Furthermore, the first connector, the second connector, and the converter board are TMDS type.

In another preferred embodiment, the electronic device further includes a third connector and a fourth connector. The third connector is disposed on the liquid crystal display. The fourth connector corresponds to the third connector, and is disposed on the converter board. The second signal is transmitted to the liquid crystal display by the third connector connected to the fourth connector.

Furthermore, the third connector, the fourth connector, and the converter board are LVDS type.

Furthermore, the third connector, the fourth connector, and the converter board are TMDS type.

Furthermore, the electronic device includes a cable connecting the third connector and the liquid crystal display.

It is understood that the motherboard may be a Mini-ITX type.

In another preferred embodiment, the fixing member is a screw. The converter board includes a first through hole, and the heat dissipation module includes a screw hole corresponding to the first through hole. The converter board is fixed on the heat dissipation module by threading the screw into the screw hole via the first through hole.

In another preferred embodiment, the cushion member may be a pad, and includes a second through hole through which the fixing member passes.

In another preferred embodiment, the cushion member is made of a heat-isolation material, such as plastic.

In this invention, a conversion module for a liquid crystal display and a motherboard is provided. The motherboard includes a heat dissipation module. The conversion module includes a converter board, a fixing member, a cushion member, a first connector, and a second connector. The converter board converts a first signal from the motherboard to a second signal suitable for use by the liquid crystal display. The fixing member connects the converter board and the heat dissipation module so that the converter board is fixed on the heat dissipation module. The cushion member is disposed between the converter board and the heat dissipation module. The first connector is disposed on the converter board and coupled to the motherboard. The second connector is disposed on the converter board and coupled to the liquid crystal display. The first signal is transmitted to the converter board and the second signal is transmitted to the liquid crystal display by the first connector and the second connector.

### BRIEF DESCRIPTION OF THE DRAWINGS

The present invention can be more fully understood by reading the subsequent detailed description and examples with references made to the accompanying drawings, wherein:

FIG. 1 is a schematic view of a conventional desktop computer;

FIG. 2 is a schematic view of an electronic device with a minimized motherboard as disclosed in the co-pending U.S. application Ser. No. 10/646,733;

FIG. 3a is a perspective schematic view of an electronic device as disclosed in this invention; and

FIG. 3b is a side schematic view of the electronic device as shown in FIG. 3a.

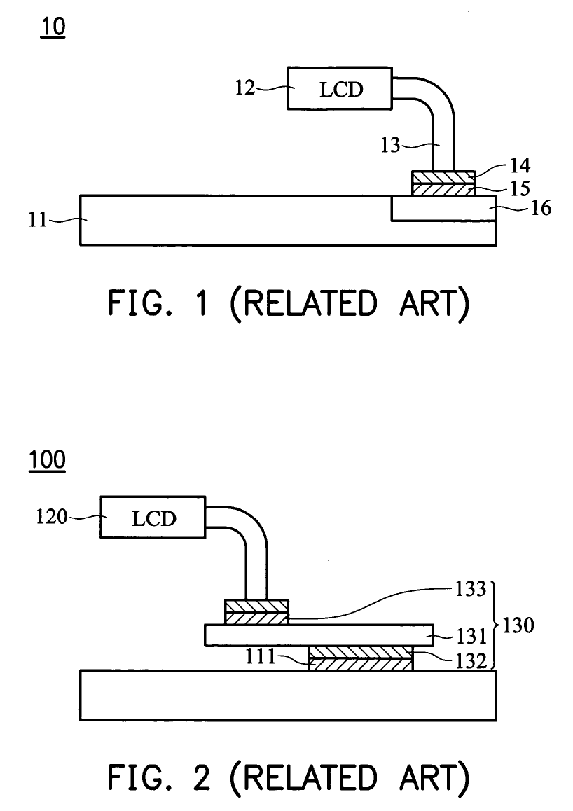

### DETAILED DESCRIPTION OF THE INVENTION

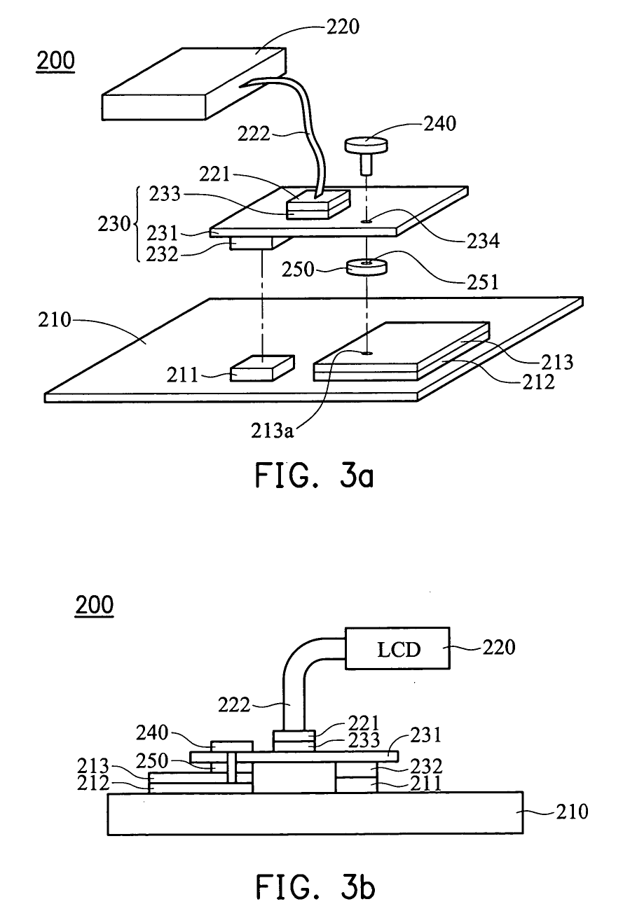

FIG. 3a and FIG. 3b show an electronic device 200 as disclosed in this invention. The electronic device 200 includes a motherboard 210, a liquid crystal display 220, and a conversion module 230 for the liquid crystal display 220, a fixing member 240, and a cushion member 250.

The motherboard 210 includes a connector 211, a chipset 212, and a heat dissipation module 213. The connector 211 is connected to the conversion module 230. The chipset 212 may be a north bridge chip or a south bridge chip. The heat dissipation module 213 dissipates the heat generated by the chipset 212, and includes a screw hole 213a thereon.

The liquid crystal display 220 includes a cable 222, and a connector 221 is disposed at one end of the cable 222. The connector 221 is connected to the conversion module 230.

The conversion module 230 is connected to the heat dissipation module 213 of the motherboard 210, and includes a converter board 231 and connectors 232, 233. The connector 232 is disposed on one surface of the converter board 231, and corresponds to the connector 211 on the motherboard 210 so as to be connected to the connector 211. By means of the connectors 232, 211, the conversion module 230 is coupled to the motherboard 210. The connector 233 is disposed on another surface of the converter board 231, and is located opposite to the connector 232. The connector 233 corresponds to the connector 221 so as to be connected to the connector 221. By means of the connectors 233, 221, the conversion module 230 is coupled to the liquid crystal display 220.

The converter board 231 includes a through hole 234 and a converting circuit (not shown), and converts a first signal from the motherboard 210 to a second signal suitable for use by the liquid crystal display 220. That is, by means of the converter board 231 and the connectors 232, 233, the signal from the motherboard 210 can be converted into a signal suitable for use by the liquid crystal display 220.

The fixing member 240 is threaded into the screw hole 213a of the heat dissipation module 213 through the through hole 234 of the converter board 231 so that the converter board 231 is fixed on the heat dissipation module 213. It is understood that the fixing member 240 may be a screw. In addition, although only one fixing member 240 is shown in FIG. 3a and FIG. 3b; however, it is not limited to this. The number of the fixing member 240 may be adjusted to satisfy different requirements.

The cushion member 250 includes a through hole 251 through which the fixing member 240 passes, and is disposed between the converter board 231 and the heat dissipation module 213. Thus, arrangement of the combined converter board 231 and heat dissipation module 213 is more flexible. In addition, although only one cushion member 250 is shown in FIG. 3a and FIG. 3b; however, it is not limited to this. The number of the cushion member 250 depends on the number of the fixing member 240.

In addition, the cushion member 250 may be made of a heat-isolation material, such as plastic. Thus, heat from the heat dissipation module 213 is not transmitted to the converter board 231.

It is understood that the types of connectors and the converter board depend on the specification of the liquid crystal display. For example, the connectors and the converter board may be LVDS type or TMDS type.

Furthermore, it is understood that since the design of this invention is adapted to small motherboards, the motherboard may be a Mini-ITX type.

In addition, it is understood that the electronic device may be a desktop computer, and the liquid crystal display may be a liquid crystal display module (LCM).

As stated above, the space occupied by the motherboard can be reduced, and the arrangement between the motherboard and the conversion module becomes more stable. Furthermore, it is understood that the total height of the combined motherboard and the conversion module should not be higher than that of the original motherboard, thus increasing available space around the motherboard.

While the invention has been described by way of example and in terms of the preferred embodiment, it is to be understood that the invention is not limited to the disclosed embodiment. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device comprising:
a liquid crystal display;
a motherboard including a heat dissipation module;
a converter board, connected to the heat dissipation module and coupled to the motherboard and the liquid crystal display respectively, for converting a first signal from the motherboard to a second signal suitable for use by the liquid crystal display;
a fixing member connecting the converter board and the heat dissipation module so that the converter board is fixed on the heat dissipation module; and
a cushion member disposed between the converter board and the heat dissipation module.

2. The electronic device as claimed in claim 1, further comprising:
a first connector disposed on the motherboard; and
a second connector, corresponding to the first connector, disposed on the converter board, wherein the first signal is transmitted to the converter board by the first connector connected to the second connector.

3. The electronic device as claimed in claim 2, wherein both the first connector and the second connector are LVDS type.

4. The electronic device as claimed in claim 3, wherein the converter board is LVDS type.

5. The electronic device as claimed in claim 2, wherein both the first connector and the second connector are TMDS type.

6. The electronic device as claimed in claim 5, wherein the converter board is TMDS type.

7. The electronic device as claimed in claim 1, further comprising:
a third connector disposed on the liquid crystal display; and
a fourth connector, corresponding to the third connector, disposed on the converter board, wherein the second signal is transmitted to the liquid crystal display by the third connector connecting to the fourth connector.

8. The electronic device as claimed in claim 7, wherein both the third connector and the fourth connector are LVDS type.

9. The electronic device as claimed in claim 8, wherein the converter board is LVDS type.

10. The electronic device as claimed in claim 7, wherein both the third connector and the fourth connector are TMDS type.

11. The electronic device as claimed in claim 10, wherein the converter board is TMDS type.

12. The electronic device as claimed in claim 7, further comprising:
a cable connecting the third connector and the liquid crystal display.

13. The electronic device as claimed in claim 1, wherein the motherboard is a Mini-ITX type.

14. The electronic device as claimed in claim 1, wherein the fixing member is a screw.

15. The electronic device as claimed in claim 14, wherein the converter board includes a first through hole, and the heat dissipation module includes a screw hole corresponding to the first through hole, and the converter board is fixed on the heat dissipation module by threading the screw into the screw hole via the first through hole.

16. The electronic device as claimed in claim 1, wherein the cushion member is a pad.

17. The electronic device as claimed in claim 1, wherein the cushion member includes a second through hole through which the fixing member passes.

18. The electronic device as claimed in claim 1, wherein the cushion member is made of a heat-isolation material.

19. The electronic device as claimed in claim 18, wherein the cushion member is made of plastic.

20. The electronic device as claimed in claim 1, wherein the liquid crystal display is a liquid crystal display module.

21. A conversion module for a liquid crystal display and a motherboard, wherein the motherboard includes a heat dissipation module, and the conversion module comprises:
a converter board, connected to the heat dissipation module, for converting a first signal from the motherboard to a second signal suitable for use by the liquid crystal display;
a fixing member connecting the converter board and the heat dissipation module so that the converter board is fixed on the heat dissipation module;
a cushion member disposed between the converter board and the heat dissipation module;
a first connector disposed on the converter board and coupled to the motherboard; and
a second connector disposed on the converter board and coupled to the liquid crystal display, wherein the first signal is transmitted to the converter board and the second signal is transmitted to the liquid crystal display by the first connector and the second connector.

22. The conversion module as claimed in claim 21, wherein the first connector and the second connector are located at opposite sides of the converter board.

23. The conversion module as claimed in claim 21, wherein both the first connector and the second connector are LVDS type.

24. The conversion module as claimed in claim 21, wherein the converter board is LVDS type.

25. The conversion module as claimed in claim 21, wherein both the first connector and the second connector are TMDS type.

26. The conversion module as claimed in claim 25, wherein the converter board is TMDS type.

27. The conversion module as claimed in claim 21, further comprising:
a cable connecting the second connector and the liquid crystal display.

28. The conversion module as claimed in claim 21, wherein the fixing member is a screw.

29. The conversion module as claimed in claim 28, wherein the converter board includes a first through hole, and the heat dissipation module includes a screw hole corresponding to the first through hole, and the converter board is fixed on the heat dissipation module by threading the screw into the screw hole via the first through hole.

30. The conversion module as claimed in claim 21, wherein the cushion member is a pad.

31. The conversion module as claimed in claim 21, wherein the cushion member includes a second through hole through which the fixing member passes.

32. The conversion module as claimed in claim 21, wherein the cushion member is made of a heat-isolation material.

33. The conversion module as claimed in claim 32, wherein the cushion member is made of plastic.
